(19) United States
(12) Patent Application Publication
(10) Pub. No.: US 2022/0182285 A1
(43) Pub. Date: Jun. 9, 2022

(54) UPDATING CONFIGURATION DATA IN A CONTENT DELIVERY NETWORK

(71) Applicant: Level 3 Communications, LLC, Broomfield, CO (US)

(72) Inventor: William CROWDER, Camarillo, CA (US)

(73) Assignee: Level 3 Communications, LLC, Broomfield, CO (US)

(21) Appl. No.: 17/321,106

(22) Filed: May 14, 2021

Related U.S. Application Data
(60) Provisional application No. 63/122,376, filed on Dec. 7, 2020.

(51) Int. Cl. H04L 12/24; H04L 29/06

(52) U.S. Cl. CPC H04L 41/0856; H04L 63/168; H04L 41/0863; H04L 41/0853

(57) ABSTRACT

Examples described herein relate to systems and methods for updating configuration data. A method implemented by a computer may include receiving updated configuration data from a control core. Earlier configuration data with a time stamp may be stored in an archive storing additional earlier configuration data with respective time stamps. Responsive to the updated configuration data not being faulty, content may be distributed using the updated configuration data. Responsive to the updated configuration data being faulty, a fault may be communicated to a monitoring system, and commands from the monitoring system may be received and executed to: revert to an earlier configuration data corresponding to a specific earlier time, and disregard any further updated configuration data from the control core until instructed otherwise by the monitoring system. Content may be distributed using the earlier configuration data to which the computer is reverted.

### CROSS-REFERENCE TO RELATED APPLICATIONS

This application claims the benefit of U.S. Provisional Patent Application No. 63/122,376, filed Dec. 7, 2020 and entitled “Updating Configuration Data in a Content Delivery Network,” the entire contents of which are incorporated by reference herein.

### BACKGROUND

A content delivery network (CDN) includes a geographically distributed network of servers configured for facilitating distribution of content items (e.g., videos, images, website content data, and so on) from an origin server to clients that consume the content items. Each server in the CDN can be referred to as a node, a machine, a computer, and so on. To distribute the content items to clients that are geographically remote to the origin server, a node in geographical proximity to the clients can provide the content items to those clients on behalf of the origin server. Additional components in the CDN can participate in or control the distribution of content items to clients. For example, the CDN can include a control core that controls nodes in the CDN, e.g., regularly transmits updated configuration data such as commands for nodes to implement. Accordingly, if configuration data is faulty, it can be distributed to and implemented by multiple nodes in the CDN, which may cause the nodes' respective software applications implementing that configuration data to crash or otherwise misbehave in such a manner as to disrupt the distribution of content items in the CDN.

### BRIEF SUMMARY

Provided herein are systems and methods for updating configuration data in a content delivery network (CDN).

A method for updating configuration data by a computer is provided herein. The method may be implemented by the computer and may include receiving updated configuration data from a control core. The method may include storing earlier configuration data with a time stamp in an archive storing additional earlier configuration data with respective time stamps. The method may include, responsive to the updated configuration data not being faulty, distributing content using the updated configuration data. The method may include, responsive to the updated configuration data being faulty, communicating a fault to a monitoring system; receiving and executing commands from the monitoring system to: revert to an earlier configuration data stored in the archive and corresponding to a specific earlier time and disregard any further updated configuration data from the control core until instructed otherwise by the monitoring system; and distribute content using the earlier configuration data to which the computer is reverted.

In some examples, the method further includes validating the updated configuration data. The earlier configuration data may be stored in the archive responsive to successfully validating the updated configuration data. In some examples, the archive stores all earlier configuration data with respective time stamps within a predefined, rolling time window, and discards earlier configuration data with time stamps prior to that window. The window may be 24 hours or less prior to a current time.

In some examples, the computer includes a node in a content delivery network (CDN).

In some examples, the archive is stored in a mass storage device of the computer.

In some examples, the commands from the monitoring system use a secure shell (SSH) protocol.

A computer system including a processor, a storage device, and a network interface is provided herein. The processor may be configured to implement operations including receiving updated configuration data from a control core. The operations may include storing earlier configuration data with a time stamp in an archive storing additional earlier configuration data with respective time stamps. The operations may include, responsive to the updated configuration data not being faulty, distributing content using the updated configuration data. The operations may include, responsive to the updated configuration data being faulty, communicating a fault to a monitoring system; receiving and executing commands from the monitoring system to revert to an earlier configuration data stored in the archive and corresponding to a specific earlier time and disregard any further updated configuration data from the control core until instructed otherwise by the monitoring system; and distribute content using the earlier configuration data to which the computer is reverted.

In some examples, the operations further include validating the updated configuration data. The earlier configuration data may be stored in the archive responsive to successfully validating the updated configuration data.

In some examples, the archive stores all earlier configuration data with respective time stamps within a predefined, rolling time window, and discards earlier configuration data with time stamps prior to that window. In some examples, the window is 24 hours or less prior to a current time.

In some examples, the computer system includes a node in a content delivery network (CDN).

In some examples, the archive is stored in the storage device.

In some examples, the commands from the monitoring system use a secure shell (SSH) protocol.

A method for updating configuration data is provided herein. The method may be implemented by a computer and includes receiving respective communications of fault from one or more nodes after the nodes receive updated configuration data from a control core. The method also may include, responsive to receiving the communications of fault, commanding the one or more nodes to revert to earlier configuration data corresponding to a specific earlier time, and disregard any further updated configuration data from the control core until instructed otherwise.

In some examples, the specific earlier time is 24 hours or less prior to a current time.

In some examples, the computer includes a monitoring system in a content delivery network (CDN).

A computer system comprising a processor and a network interface is provided herein. The processor may be configured to implement operations that include receiving respective communications of fault from one or more nodes after the nodes receive updated configuration data from a control core. The operations may include, responsive to receiving the communications of fault, commanding the one or more nodes to revert to earlier configuration data corresponding to a specific earlier time, and disregard any further updated configuration data from the control core until instructed otherwise.

In some examples, the specific earlier time is 24 hours or less prior to a current time.

In some examples, the computer system includes a monitoring system in a content delivery network (CDN).

A method for updating configuration data by a computer is provided herein. The method may be implemented by the computer and may include receiving a software update from a server. The method may include storing an earlier software version with a time stamp in an archive storing additional earlier software versions with respective time stamps. The method may include, responsive to the software update not being faulty, operating the software using the software update. The method may include, responsive to the software update being faulty, communicating a fault to a monitoring system; receiving and executing commands from the monitoring system to: revert to an earlier software version stored in the archive and corresponding to a specific earlier time and disregard any further software updates from the server until instructed otherwise by the monitoring system; and operating the software using the software version to which the computer is reverted.

A method for updating configuration data is provided herein. The method may be implemented by a computer and may include receiving respective communications of fault from one or more computers after the computers receive a software update from a server. The method may include, responsive to receiving the communications of fault, commanding the one or more computers to revert to an earlier software version corresponding to a specific earlier time, and disregard any further software updates from the server until instructed otherwise.

These and other features, together with the organization and manner of operation thereof, will become apparent from the following detailed description when taken in conjunction with the accompanying drawings.

### BRIEF DESCRIPTION OF THE DRAWINGS

FIG. 1 is a diagram of a content delivery network (CDN) configured to update configuration data, according to various embodiments.

FIGS. 2A-2F are diagrams of example operator interfaces that may be displayed using a monitoring system in the CDN of FIG. 1, according to various embodiments.

FIG. 3 is a flow diagram illustrating a method for updating configuration data in a CDN, according to various embodiments.

FIG. 4 is a flow diagram illustrating another method for updating configuration data in a CDN, according to various embodiments.

### DETAILED DESCRIPTION

Embodiments described herein relate to updating configuration data in a content delivery network (CDN). However, it should be appreciated that the present systems and methods may be implemented in any suitable computing environment and are not limited to CDNs.

In a CDN, which also may be referred to as a content delivery system, an edge node is a node that initially receives a request for one or more content items from a client. The client refers to a device operated by an end user who desires to consume or otherwise receive one or more of the content items provided by the origin server. The content item is or includes a portion, a segment, an object, a file, or a slice of data stored by the origin server and cached at various nodes throughout the CDN for provisioning to one or more of the clients, e.g., via one or more edge nodes. The origin server refers to a device operated by a customer of the CDN, which facilitates the customer in delivering the content items to respective clients. A control core may control the nodes in the CDN, e.g., may distribute updated configuration data to such nodes that independently include commands for the nodes to change configuration(s). If configuration data is faulty, then the software application of the node that is implementing that configuration will misbehave. That is, as used herein, “faulty” configuration data is configuration data that causes a software application of a node to crash or otherwise misbehave when implementing that configuration data. By “misbehave” it is meant anything other than the desired normal behavior. By “crash” it is meant a misbehavior in which the software application being executed by the node terminates abnormally and possibly restarts. A crash may include an operating system crash. Other nonlimiting examples of misbehavior can include not serving customer content correctly (whether for all customers or for one or more customers), or increased CPU and/or memory usage caused, for example, by a new configuration exposing a bug in the software application, or the like. As such, within the framework of the application the configuration data may be legal (and thus may be validated during initial checks of the configuration data), but nevertheless may expose a bug during processing. Such processing may include normal processing, or the taking of unusual code paths in response to abnormal processing.

The control core of a CDN may not act upon the configuration data that it distributes, and as such may distribute faulty configuration data without having reason to know that such configuration data is faulty, unless and until a software application on a node misbehaves as a result of implementing the configuration data and a system operator eventually identifies the source of the misbehavior. Although nodes may be able to flag—and reject prior to implementing—certain types of faulty configuration data through the validation process, nodes nonetheless may successfully validate and then implement configuration data that eventually causes software applications running on those nodes to misbehave.

As provided herein, nodes may maintain an archive of earlier configuration data with respective time stamps, and in case of a faulty configuration data update may be reverted to use the archived, earlier configuration data. For example, the CDN may include a monitoring system configured to monitor the health of the nodes. The monitoring system may be used to issue commands causing the nodes to revert to earlier configuration data that corresponds to a specific time before the faulty configuration data was distributed or implemented. Additionally, the commands may cause the nodes to ignore or reject any further updated configuration data from the control core, for example because the control core itself may be faulty or may be continuing to issue faulty configuration data, or may have crashed and thus is unable to transmit non-faulty configuration data. The commands from the monitoring system may be issued relatively quickly, e.g., in response to one or more nodes misbehaving after a configuration data update, and without the need to determine or even begin to analyze the root cause of the fault. As such, within minutes of the node(s) misbehaving, the node(s) may be reverted to an operable state at which they may distribute content. The cause of the misbehavior subsequently may be investigated and addressed while the nodes distribute content normally, albeit using an earlier version of configuration data. After the cause is addressed such that the control core may safely issue updated configuration data, the monitoring system may command the nodes to again begin receiving and implementing configuration data from the control core.

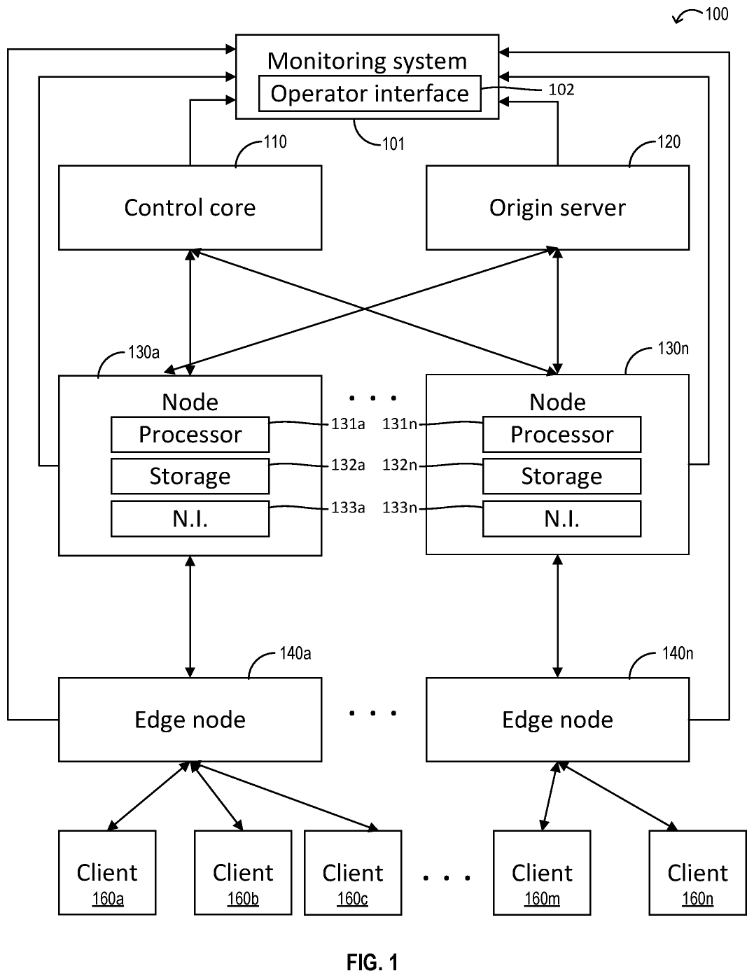

FIG. 1 is a diagram of a CDN 100 according to some embodiments. Referring to FIG. 1, the CDN 100 is configured for delivering content items provided by an origin server 120 to various clients 160a-160n via nodes 130a . . . 130n (which may be collectively referred to herein as nodes 130) and edge nodes 140a . . . 140n (which may be collectively referred to herein as nodes 140 or as edge nodes 140). Control core 110 distributes updated configuration data to nodes 130 and edge nodes 140, e.g., commands for such nodes to change configuration. Monitoring system 101 may be coupled directly or indirectly to nodes 130 and nodes 140, and optionally also may be coupled to control core 110 and/or origin server 120. Monitoring system 101 may be configured to monitor the health (e.g., fault status) of nodes 130 and nodes 140 via “out of band” communications that bypass control core 110. Monitoring system optionally may be configured to monitor updates to configuration data that control core 110 transmits to nodes 130 and nodes 140. Monitoring system 101 may include operator interface 102 via which the health of nodes 130 and 140 may be displayed to an operator, and which may be used to receive input from the operator instructing that configuration data of any suitable ones (or all) of nodes 130 and nodes 140 be reverted to that of an earlier time in a manner such as described in greater detail herein.

A user of a respective one of the clients 160a-160n may request and receive the content items provided by the origin server 120 via node(s) 130, 140. In some embodiments, each of the clients 160a-160n can be a desktop computer, mainframe computer, laptop computer, pad device, smart phone device, or the like, configured with hardware and software to perform operations described herein. For example, each of the clients 160a-160n includes a network device and a user interface. The network device is configured to connect the clients 160a-160n to a node (e.g., an edge node 140) of the CDN 100. The user interface is configured for outputting (e.g., displaying media content, games, information, and so on) based on the content items as well as receiving user input from the users.

In some examples, the CDN 100 is configured for delivering and distributing the content items originating from the origin server 120 to the clients 160a-160n. For example, the CDN 100 includes nodes 130, 140, where the origin server 120 is connected directly or indirectly to some or all of nodes 130a . . . 130n, and each of nodes 130a . . . 130n is connected directly or indirectly to at least one corresponding edge node 140a . . . 140n. The monitoring system 101, control core 110, origin server 120, the nodes 130, the edge nodes 140, and any other components in the CDN 100 can be located in different locations, thus forming the geographically distributed CDN 100. While there can be additional nodes between the nodes 130 and the origin server 120, the nodes 130 can be directly connected to the origin server 120, or the nodes 130 can be the origin server 120. In some configurations, monitoring system 101, nodes 130, and edge nodes 140 may be configured to implement the present functionality for updating configuration data that is distributed by control core 110.

The content items of the origin server 120 can be replicated and cached in multiple locations (e.g., multiple nodes) throughout the CDN 100, including in the nodes 130, 140 and other nodes (not shown). As used herein, the node 130 refers to any node in the CDN 100 (between the origin server 120 and the edge node 140) that stores copies of content items provided by the origin server 120. The origin server 120 refers to the source of the content items. The origin server 120 can belong to a customer (e.g., a content owner, content publisher, or a subscriber of the system 100) of the CDN 100 such that the customer pays a fee for using the CDN 100 to deliver the content items. Examples of content items include, but are not limited to, webpages and web objects (e.g., text, graphics, scripts, and the like), downloadable objects (e.g., media files, software, documents, and the like), live streaming media, on-demand streaming media, social networks, and applications (e.g., online multiplayer games, dating applications, e-commerce applications, portals, and the like), and so on.

The nodes 130, 140, and any other nodes (not shown) between the edge nodes 140 and the origin server 120 form a “backbone” of the CDN 100, providing a path from the origin server 120 to the clients 160a-160n. The nodes 130 are upstream with respect to the edge nodes 140 given that the nodes 130 are between respective edge nodes 140 and the origin server 120 as well as control core 110, the edge nodes 140 are downstream of nodes 130, and nodes 130 are downstream of origin server 120 and control core 110. In some embodiments, the edge node 140 is referred to as an “edge node” given the proximity of the edge node 140 to the clients 160a-160n. In some embodiments, the node 130 (and any other nodes between the node 130 and the origin server 120 not shown) is referred to as an “intermediate node.” The intermediate nodes link the edge nodes 140 to the origin server 120 and to control core 110 via various network links or “hops.” The intermediate nodes can provide the content items (and updates thereof) to the edge nodes, and also can distribute updated configuration data to the edge nodes. That is, the origin server 120 can provide the content items (and updates thereof) to the edge node 140 through the node 130, if the edge node 140 does not currently cache a copy of the content items respectively requested by the clients 160a-160n. Additionally, control core 110 can provide updated configuration data to the edge nodes 140 through the nodes 130.

Each link between one of the clients 160a-160n and the edge node 140 corresponds to a suitable network connection for exchanging data, such as content items or configuration data. In addition, each link between the nodes/servers 130, 140, . . . , 110, and 120 represents a suitable network connection for exchanging data such as content items or configuration data. A network connection is structured to permit the exchange of content items and configuration data, e.g., data, values, instructions, messages, and the like, among the clients 160a-160n, the nodes 130, 140, and so on, and the control core 110 and origin server 120 in the manner shown. The network connection can be any suitable Local Area Network (LAN) or Wide Area Network (WAN) connection. For example, each network link can be supported by Frequency Division Multiple Access (FDMA), Time Division Multiple Access (TDMA), Synchronous Optical Network (SONET), Dense Wavelength Division Multiplexing (DWDM), Optical Transport Network (OTN), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like.

In the example configuration illustrated in FIG. 1, each of nodes 130 and 140 is configured to revert to earlier configuration data in the circumstance that faulty configuration data is distributed by control core 110. For example, each of nodes 130a . . . 130n is a computer system that includes a respective processor 131a . . . 131n, storage 132a . . . 132n, and network interface (N.I.) 133a . . . 133n; nodes 140a . . . 140n may be configured similarly. Control core 110 may distribute configuration data to nodes 130 and 140. Examples of configuration data that may be distributed by control core 110 include, but are not limited to, commands for downstream nodes (such as one or both of nodes 130 and 140) to change configuration. Nonlimiting examples of commands to change configuration that control core 110 may include within updated configuration data include, but are not limited to, change configuration for a particular customer, or change a configuration setting such as, illustratively, to refer to a new geographic information database. The configuration data distributed by control core 110 to nodes 130 and 140 may be faulty, e.g., may contain an error that would cause a software application running on a node in CDN 100 (e.g., one or more of nodes 130, 140) to misbehave. The faultiness of that configuration data may be inadvertent, e.g., may include an inadvertent command error that would cause the software application to misbehave, or may contain or point to data the processing of which causes the software application to misbehave. For example, the data may be faulty, and the software's correct processing of the faulty data causes misbehavior; illustratively, a geo database that contains incorrect country code information for a set of IP addresses may cause software to misbehave. Or, for example, the data may expose a latent fault in the software. Examples of inadvertent command errors include, but are not limited to, coding errors leading to unrecoverable processing faults, which may be most likely in failure recovery code paths, or attempts to allocate more resources (e.g., memory) than are available. However, it will be appreciated that the faultiness of that configuration data may be intentional, e.g., may include an intentional error, introduced by a malicious entity, that would cause the software application to misbehave.

Processors 131a . . . 131n (and similar processors in nodes 140) may be implemented with a general-purpose processor, an Application Specific Integrated Circuit (ASIC), one or more Field Programmable Gate Arrays (FPGAs), a Digital Signal Processor (DSP), a group of processing components, or other suitable electronic processing components. Processors 131a . . . 131n respectively may include or may be coupled to storage 132a . . . 132n, e.g., a Random Access Memory (RAM), Read-Only Memory (ROM), Non-Volatile RAM (NVRAM), flash memory, hard disk storage, or another suitable data storage unit, which stores data and/or computer code for facilitating the various processes executed by the processors. The storage may be or include tangible, non-transient volatile memory or non-volatile memory. Accordingly, the storage may include database components, object code components, script components, or any other type of information structure for supporting the various functions described herein, such as an archive. Each storage 132a . . . 132n (and similar storage in nodes 140) can include a mass storage device, such as a hard disk drive or solid state drive. Network interfaces 133a . . . 133n (and similar network interfaces in nodes 140) include any suitable combination of hardware and software to establish communication with clients (e.g., the clients 160a-160n), other nodes in the CDN 100 such as respective edge nodes 140a . . . 140n, control core 110, and origin server 120 as appropriate. In some implementations, the network interfaces 133a . . . 133n include a cellular transceiver (configured for cellular standards), a local wireless network transceiver (for 802.11X, ZigBee, Bluetooth, Wi-Fi, or the like), a wired network interface, a combination thereof (e.g., both a cellular transceiver and a Bluetooth transceiver), and/or the like.

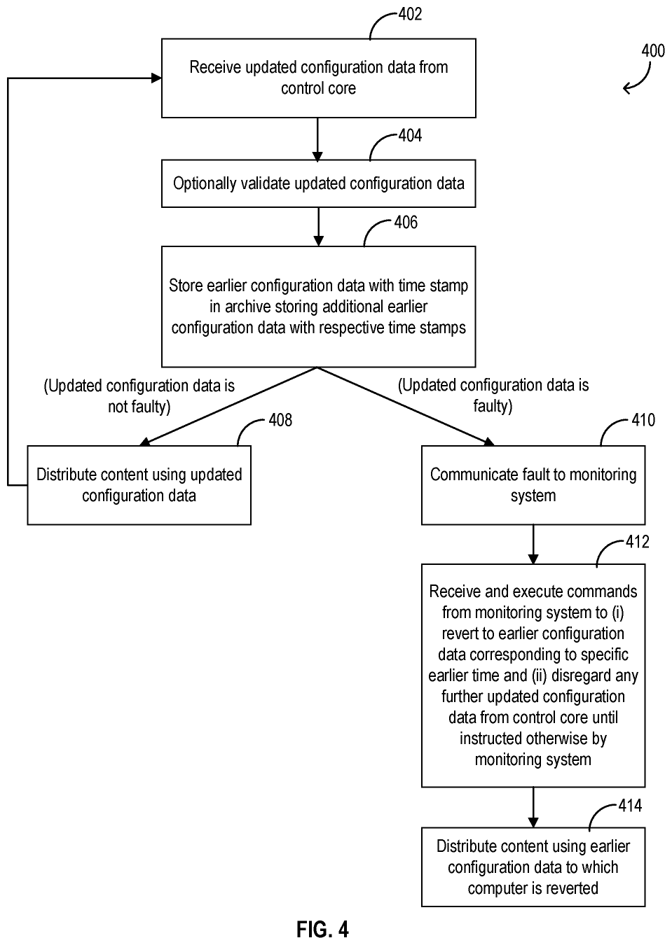

Processors 131a . . . 131n (and similar processors in nodes 140) may be configured to implement operations for updating configuration data in a manner such as provided herein, including as described further below with reference to FIG. 4. In examples such as illustrated in FIG. 1, each processor 131a . . . 131n may be configured to cause respective storage 132a . . . 132b to store updated configuration data received directly or indirectly from control core 110 via network interface 133a . . . 133n. The updated configuration data may be faulty or non-faulty. When the updated configuration data is faulty, the fault may be detected at the outset, or the fault may not be detectable until after the node implements the configuration data. For example, each processor 131a . . . 131n may be configured to validate the updated configuration data and to reject it if the configuration data is determined at the outset to be faulty, in which case the validation process itself protects the node 130 or 140 from implementing the faulty configuration data. In a nonlimiting, purely illustrative example in which the updated configuration data is a reference to a new geographical information database, the node may check whether the reference is in a valid format and whether the new database contains significantly less information than a previous database. Responsive to the updated configuration data not being faulty, processors 131a . . . 131n (may distribute content to clients 160a . . . 160n using the updated configuration data.

However, if the fault in the updated configuration data is of a nature that the validation process does not flag it, then the node 130 or 140 may implement the updated configuration data and subsequently misbehave as a result, e.g., when attempting to distribute content to clients 160a . . . 160n using the updated configuration data. Depending on the nature of the fault, the misbehavior may occur immediately or may be delayed. As provided herein, an archive, stored within storage 132a . . . 132n, of earlier configuration data with time stamps may be used to protect nodes 130 and 140 from updated configuration data that includes a fault that is not detected prior to implementation, e.g., that is not detected during a pre-implementation validation process. More specifically, each processor 131a . . . 131n may be configured to store earlier configuration data with a time stamp in an archive within respective storage 132a . . . 132n, for example, responsive to receiving and validating the updated configuration data from control core 110. The time stamp may indicate, for example, a time at which the earlier configuration data was created by control core 110, transmitted by control core 110, received by node 130 or 140, initially implemented by node 130 or 140, or stored at node 130 or 140. The archive may store all earlier configuration data with respective time stamps that are within a predefined, rolling time window, and may discard earlier configuration data with time stamps prior to that window. The window may, for example, be any suitable time duration prior to a current time, e.g., 48 hours or less, 24 hours or less, 12 hours or less, or the like. Illustratively, the processors of nodes 130 and 140 may be configured to refresh the archive by comparing the time stamps of earlier configuration data within the archive to the time window, and to discard earlier configuration data falling outside of that window, e.g., with a time stamp that is 48 hours or more, 24 hours or more, or 12 hours or more, or 6 hours or more, earlier than the current time. Alternatively, the archive may store all earlier configuration data ever received by the node.

The archive of earlier configuration data with respective time stamps may be used to revert node 130 or 140 to a configuration which is believed to be non-faulty. It will be appreciated that such archive may not be needed or used unless and until the node 130 or 140 implements updated configuration data that actually causes a fault which is communicated to monitoring system 101 or which otherwise manifests itself, e.g., is reported by one or more customers. For example, processors of nodes 130 and 140 may be configured, responsive to the updated configuration data being faulty (e.g., causing a crash or other misbehavior), to communicate the fault to monitoring system 101. Such communication may be performed expressly by transmitting a report from the node to monitoring system 101 using a suitable protocol, such as a secure shell (SSH) protocol, to report, illustratively, the node's resource consumption (e.g., memory or CPU) increasing even while maintaining otherwise healthy output, or the node exhibiting an increased rate of error responses (e.g., hypertext transfer protocol (HTTP) error responses). Alternatively, such communication may be performed implicitly, e.g., by the node going silent because the node has crashed, the node's resource consumption (e.g., memory or CPU) increasing even while maintaining otherwise healthy output, the node serving incorrect content, or the node exhibiting an increased rate of error responses (e.g., HTTP error responses). In still other examples, the fault is communicated to the monitoring system via an aggregate of nodes which are exhibiting more subtle symptoms of misbehavior that, if observed for a single node, may not necessarily suggest a problem.

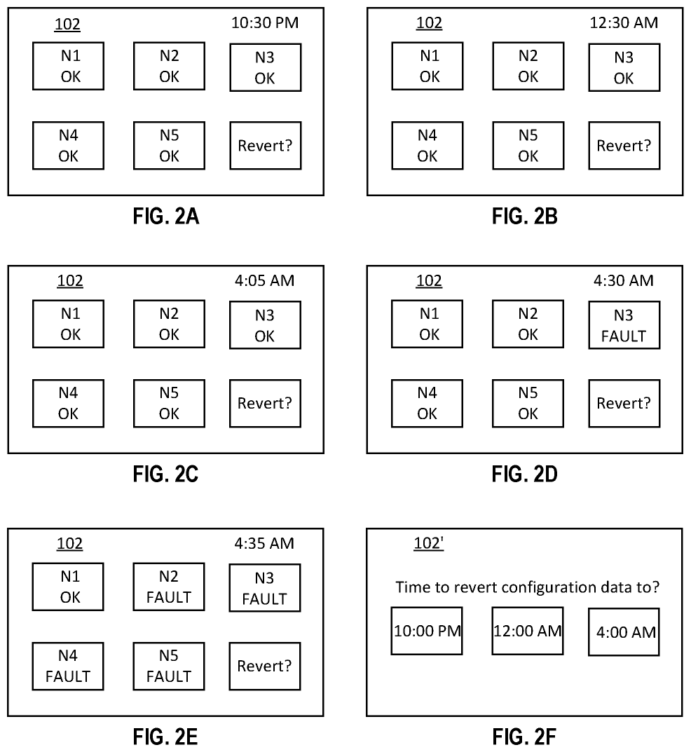

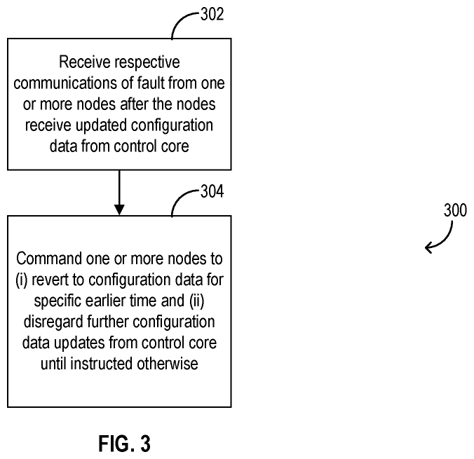

In a manner such as described in greater detail below with reference to FIGS. 2A-2F and 3, responsive to receiving such a communication of the fault, monitoring system 101 may transmit commands to the node 130 or 140 for use in reverting that node to use earlier configuration data, e.g., commanding the nodes to revert to earlier configuration data corresponding to a specific earlier time, and to disregard any further updated configuration data from control core 110 until instructed otherwise. The commands from monitoring system 101 may use the same protocol as the communication from node 130 or 140, e.g., may use SSH protocol.

Responsive to the commands received from monitoring system 101, node 130 or 140 reverts to an earlier configuration data corresponding to the specific earlier time indicated in the commands, disregards any further updated configuration data from the control core until instructed otherwise by the monitoring system, and distributes content using the reverted earlier configuration data. For example, the processor of node 130 or 140 may be configured to compare the specific earlier time (indicated in the commands from monitoring system 101) to the respective time stamps of earlier configuration data stored in the archive, and to select a particular version of the earlier configuration data based on that comparison. Illustratively, the processor of node 130 or 140 may be configured to select a particular version of the earlier configuration data based on that version's respective time stamp being the overall closest to the specific earlier time indicated in the commands, or based on the respective time stamp being the closest one that precedes the specific earlier time indicated in the commands. Alternatively, in a system where configuration data versions have unique identifying information (e.g., a sequence number), the operator may use the identifying information to select and specify a version of configuration data that is believed to be good, rather than a time value. The processor of node 130 or 140 may be configured to replace the updated configuration data (which is faulty) with the selected earlier configuration data and to use the selected earlier configuration data for distributing content normally. For example, the node 130 or 140 (or software application) may be instructed either to pick up the earlier configuration data or to restart (and thereby pick up the earlier configuration data). In this regard, although node 130 or 140 may not necessarily implement all configuration changes that may have been intended by control core 110 via the updated configuration data (e.g., may not necessarily implement specific configurations that are intended by customers of CDN 100), node 130 or 140 may continue to distribute content without that updated configuration, which likely is better than the node catastrophically failing due to a fault in that updated configuration. An additional benefit of being able to use locally stored, earlier configuration data is that it may be implemented quickly as compared to configuration data that would need to be distributed across CDN 100 in order to correct the fault.

Additionally, control core 110 may in some circumstances continue to issue updated configuration data that is faulty until the nature of the fault is identified and addressed, or may itself misbehave in such a manner that it may not be able to issue any additional configuration data to correct the fault for hours or longer. So as to excise control core 110 from the pathway for restoring node 130 or 140, the processor of node 130 or 140 may be configured to, responsive to the commands from monitoring system 101, disregard any further such updates from the control core unless and until that node receives a subsequent command the monitoring system authorizing the node to receive and implement such updates. The processor of node 130 or 140 optionally may be configured to store the updated configuration data in storage (e.g., separately from the archive), so that the faulty configuration data may be analyzed at a later time to determine the nature of the fault.

As noted further above, monitoring system 101 may be coupled to each of nodes 130 and 140 in such a manner as to receive communication of fault from such nodes, and to issue commands to such nodes for use in reverting those nodes to earlier configuration data when appropriate. Monitoring system 101 may include operator interface 102 via which the monitoring system may communicate the fault status of nodes in CDN 100 to an operator and may receive input from the operator regarding reverting the configuration data of such nodes. The operator may use operator interface 102 to monitor the status of nodes in CDN 100 and to respond in an ad hoc manner to perceived misbehavior of nodes, e.g., by using operator interface 102 to issue commands from monitoring system 101 to nodes 130 and 140. Monitoring system 101 may be considered to provide a disaster recovery mechanism that is usable even if control core 110 is unavailable or is misbehaving. Operator interface 102 may be used to issue a “revert to time X” command available on the nodes themselves, and the operator(s) of monitoring system 101 may choose to invoke the command by as appropriate and independently of the control core 110 or other command pathways. Monitoring system 101 may allow quick recovery to a known state based on time using simple commands that can be issued in any number of ways.

For example, FIGS. 2A-2F are diagrams of example operator interfaces that may be displayed using a monitoring system in the CDN of FIG. 1, according to various embodiments. Interface 102 may display the fault status of a plurality of nodes (illustratively, nodes N1, N2, N3, N4, and N5) at the current time and day, and may provide an operator with the option to revert the configuration data of those nodes to an earlier version if appropriate. The operator may use the information displayed on interface 102 to determine whether the configuration data of nodes should be reverted, e.g., if updated configuration data may have caused those nodes to misbehave or otherwise communicate a fault. Note that monitoring system 101 does not require the operator to determine a reason for the nodes' faults—or even to know with certainty which configuration data update was faulty or even whether it was truly a fault in the configuration data that caused the misbehavior—before deciding to revert the nodes. As such, the operator may be able to instruct relatively quickly that the nodes should be reverted, and thus may help to restore the nodes to a functional state within minutes.

In one nonlimiting, purely illustrative example, control core 110 transmits non-faulty updated configuration data to nodes N1 . . . N5 at 10:00 PM and 12:00 AM, and transmits faulty updated configuration data to those nodes at 4:00 AM. As noted further above, monitoring system 101 may be in communication with control core 110, and as such may receive communications from control core 110 indicating the times at which updated configuration data is communicated to the nodes. Alternatively, monitoring system 101 may receive communications from the nodes indicating the times at which the nodes receive updated configuration data. As still a further alternative, monitoring system 101 need not have any information about times at which updated configuration data is transmitted to the nodes.

It may be seen in FIG. 2A that at 10:30 PM (30 minutes after a non-faulty configuration data update), nodes N1 . . . N5 all indicate “OK” meaning that no fault has been communicated from the nodes to monitoring system 101. It similarly may be seen in FIG. 2B that at 12:30 AM (30 minutes after another non-faulty configuration data update), nodes N1 . . . N5 all indicate “OK” meaning that no fault has been communicated from the nodes to monitoring system 101. It may be seen in FIG. 2C that at 4:05 AM (five minutes after the faulty configuration data update), nodes N1 . . . N5 all indicate “OK” meaning that no fault has been communicated from the nodes to monitoring system 101. In this example, even though the 4:00 AM configuration data was faulty, the load on the network may be sufficiently low at this time that the nodes may function normally for a while before misbehaving. However, it may be seen in FIG. 2D that at 4:30 AM (30 minutes after the faulty configuration update), node N3 has first communicated a fault to monitoring system 101, and that at 4:35 AM (35 minutes after the faulty configuration update), nodes N2, N4, and N5 also have first communicated a fault to the monitoring system. Given sufficient time, node N1 may be expected to communicate a fault as well. As a result of these faults, the nodes may have stopped distributing content to clients 160a . . . 160n and indeed may have catastrophically failed, causing substantial failure of CDN 100 for content distribution.

The operator may infer that the most recent configuration data update—or even an earlier configuration data update—was mostly likely faulty, and may use monitoring system 101 to revert the configuration data of the nodes to a specific time at which the operator believes the configuration data was not faulty. For example, at any suitable time after one or more faults are displayed on interface 102, e.g., within seconds (less than a minute) of one or more faults being displayed on the interface, or within minutes (less than an hour) of one or more faults being displayed on the interface, the operator may use the interface to enter a command to revert the nodes to earlier configuration data corresponding to a specific earlier time. In the nonlimiting example shown in FIGS. 2A-2E, interface 102 may include a “Revert?” button that, when selected, causes monitoring system 101 to display an additional interface 102′ displaying specific earlier times to which the nodes may be commanded to revert their earlier configuration data in a manner such as illustrated in FIG. 2F, and then to send such a command to the nodes responsive to selection of one of those specific earlier times. The specific earlier times that are displayed may be or include the time(s) at which updated configuration data was transmitted to the nodes and that fall within the predefined, rolling time window discussed elsewhere herein. Alternatively, the interface may permit the operator to select any desired time. It will be appreciated that any other suitable graphical user interface may be used for receiving instructions to revert configuration data to any suitable earlier time.

Continuing with the nonlimiting example illustrated in FIGS. 2A-2F, based on the operator's observation that nodes started communicating faults shortly after the 4:00 AM configuration data update, the operator may infer that the 4:00 AM update was faulty. The operator may make such inference by 4:30 AM (when node N3 first communicates fault), or may make such inference by 4:35 AM (when nodes N2, N4, and N5 first communicate fault). At any suitable time after interface 102 indicates that one or more nodes have communicated fault, the operator may use monitoring system 101 to revert the configuration data of the nodes to a specific time that is earlier than the time of the suspected faulty update. For example, at a time shortly after a first node fails (e.g., just seconds or minutes after 4:30 AM), or shortly after more than one nodes fails (e.g., just seconds or minutes after 4:35 AM), selection of the “Revert?” button causes monitoring system 101 to display interface 102′ and to receive, via such interface, the operator's instruction to revert the configuration data to a time at which the operator may infer the configuration data was not faulty, e.g., 12:00 AM.

Note that monitoring system 101 and interface 102 may not limit the operator's choice to the most recent update prior to the one suspected to be faulty. Instead, multiple options may be presented from which the operator may choose. For example, if updates were issued both at 12:00 AM and 12:05 AM, and node faults were communicated beginning at 2:00 AM, then the interface may allow the operator to choose to revert to a time that precedes both the 12:00 AM and 12:05 AM updates because either or both may have been faulty. Furthermore, nodes may not necessarily revert to the exact same version or time stamp of earlier configuration data as one another; for example, a first node may have been updated at 12:00 AM and at 4:00 AM and a second node may have been updated at 2:00 AM and at 6:00 AM, and so responsive to a command to revert to 3:00 AM or earlier, the first node may revert to its 12:00 AM version and the second node may revert to its 2:00 AM version which may be the same or different than the 12:00 AM version of the first node. Additionally, in some circumstances the time to which the operator selects to revert the nodes may be faulty, and as such may cause the nodes to communicate faults; in such a circumstance, the operator again may use interfaces 102 and 102′ to select an even earlier time to revert the configuration data of the nodes to.

The ability to revert the configuration data of a node need not be based on any substantive analysis or troubleshooting of the cause of the node's faults, and instead may be based solely on the observation that one or more of the nodes have expressly or implicitly communicated a fault at some time after updated configuration data was implemented by those node(s). As such, reverting the configuration data may be triggered at any suitable time after the node(s) communicate fault to the monitoring system, thus facilitating rapid restoration of the nodes to a functional state. Furthermore, the control core 110 need not be involved in reverting the node's configuration data, and indeed such reversion may be performed using “out of band” communication between monitoring system 101 and the nodes, thus avoiding the need to use (or fix) an already faulty component of the CDN (the control core) to attempt to fix other faulty components of the CDN (the node(s)).

Note that edge nodes 140a . . . 140n may be configured similarly as nodes 130a . . . 130n with regards to reverting to earlier configuration data, e.g., respectively may include a processor configured similarly as processor 131a . . . 131n and storage device configured similarly as storage 132a . . . 132n to store an archive. Additionally, or alternatively, any other node(s) in CDN 100 may be configured similarly as nodes 130a . . . 130n with regards to reverting to earlier configuration data, e.g., respectively may include a processor configured similarly as processor 131a . . . 131n and storage device configured similarly as storage 132a . . . 132n to store an archive.

Any suitable one or more computers or processing circuits within CDN 100 or a node therein, such as described with reference to FIGS. 1 and 2A-2F, or any other suitable computer or processing circuit, may be configured for use in a method for updating configuration data in a manner such as provided herein. For example, FIG. 3 is a flow diagram illustrating a method 300 for updating configuration data in a CDN, according to various embodiments. Method 300 described with reference to FIG. 3 may be implemented by any suitable computer comprising a processor, a storage device, and a network interface. In some examples, method 300 is performed by monitoring system 101 which may be configured in a manner such as described with reference to FIGS. 1 and 2A-2F.

Method 300 illustrated in FIG. 3 may include receiving respective communications of fault from one or more nodes after the nodes receive updated configuration data from a control core (operation 302). For example, monitoring system 101 may receive respective communications of fault from one or more of nodes 130 or nodes 140 after the nodes receive updated configuration data from control core 110 in a manner such as described with reference to FIGS. 1 and 2A-2F. Method 300 illustrated in FIG. 3 may include, responsive to receiving the communications of fault, commanding the one or more nodes to (i) revert to earlier configuration data corresponding to a specific earlier time; and (ii) disregard any further updated configuration data from the control core until instructed otherwise (operation 304). For example, monitoring system 101 may transmit such commands to one or more of nodes 130 or nodes 140, and optionally to multiple of such nodes, and further optionally to all of such nodes, responsive to receiving the communications of fault in a manner such as described with reference to FIGS. 1 and 2A-2F.

As another example, which may be used together with method 300 described with reference to FIG. 3, or may be separately from method 300, FIG. 4 is a flow diagram illustrating another method for updating configuration data in a CDN, according to various embodiments. Method 400 described with reference to FIG. 4 may be implemented by any suitable computer comprising a processor, a storage device, and a network interface. In some examples, method 400 is performed by node 130 or node 140 which may be configured in a manner such as described with reference to FIGS. 1 and 2A-2F.

Method 400 illustrated in FIG. 4 may include receiving updated configuration data from a control core (operation 402). For example, node 130 or node 140 described with reference to FIG. 1 may receive updated configuration data from control core 110. The control core may transmit such updated configuration data from time to time, e.g., periodically or aperiodically over the course of a day or over the course of a week, for example.

Method 400 illustrated in FIG. 4 optionally may include validating the updated configuration data (operation 404). For example, node 130 or node 140 described with reference to FIG. 1 may perform a validation process on the updated configuration data received from control core 110. If the updated configuration data does not pass the validation process, then it may be rejected without being implemented and without executing the remaining operations described with reference to FIG. 4. However, it will be appreciated that such a validation process is not required in order to implement the other operations described with reference to FIG. 4.

Method 400 illustrated in FIG. 4 further may include storing earlier configuration data with a time stamp in an archive storing additional earlier configuration data with respective time stamps (operation 406). For example, node 130 or node 140 described with reference to FIG. 1 may store its most recent version of configuration data within an archive, together with a time stamp such as described elsewhere herein. The archive further may include still other versions of earlier configuration data with time stamps, e.g., such as described elsewhere herein. In examples in which method 400 includes validating the updated configuration data, the earlier configuration data may be stored in the archive responsive to successfully validating the updated configuration data.

As described herein, the updated configuration data received at operation 402 may be faulty, or may not be faulty, and the existence of such fault may not be known unless and until the updated configuration data is actually implemented. Method 400 illustrated in FIG. 4 may include, responsive to the updated configuration data not being faulty, distributing content using the updated configuration data (operation 408). For example, node 130 or node 140 described with reference to FIG. 1 may distribute content as normal, using the updated configuration data.

Method 400 illustrated in FIG. 4 may include, responsive to the updated configuration data being faulty, communicating a fault to a monitoring system (operation 410). Nonlimiting examples of the manner in which node 130 or node 140 may communicate fault to monitoring system 101 are described elsewhere herein. Method 400 illustrated in FIG. 4 may include, responsive to the updated configuration data being faulty, receiving and executing commands from the monitoring system to (i) revert to an earlier configuration data stored in the archive and corresponding to a specific earlier time; and (ii) disregard any further updated configuration data from the control core until instructed otherwise by the monitoring system (operation 412). Note that the use of numerals (i) and (ii) herein is not intended to suggest that the operations must be performed in any particular order relative to one another. Method 400 illustrated in FIG. 4 may include, responsive to the updated configuration data being faulty, distributing content using the earlier configuration data to which the computer is reverted (operation 414). For example, after implementing the commands from monitoring system 101 to revert to earlier configuration data, node 130 or node 140 may distribute content normally, albeit with an earlier version of configuration data that may omit one or more configuration commands that were provided in the updated configuration data. As such, the node(s) of the CDN may be returned to a functional state relatively quickly and without the need to troubleshoot the cause of the fault or to restore any functionality of the control core.

It will be appreciated that the present systems and methods may be adapted for use in any kind of computer network, and are not limited to use in a CDN. For example, any kind of computer (e.g., server or client) may receive software updates from a server, and any given one of the software updates may or may not be faulty. The computer may store an archive of earlier software versions with respective time stamps in storage in a manner similar to that described herein, for use in reverting to one or more of such earlier software updates if appropriate. Responsive to the software update not being faulty, the computer may use the software update to perform its normal functionality. Responsive to the software update being faulty, the computer may communicate the fault to a monitoring system via an “out of band” communication that bypasses the server that issued the faulty software update in a manner similar to that described elsewhere herein. The monitoring system may transmit commands to the computer to (i) revert to an earlier software version corresponding to a specific earlier time and (ii) disregard any further software updates from the server that issued the faulty software update until instructed otherwise by the monitoring system. The computer may implement such commands which may restore the computer software to a functional state, albeit using an earlier version of the software that may omit one or more commands that were provided in the software update. As such, the computer software may be returned to a functional state relatively quickly and without the need to troubleshoot the cause of the fault or to restore any functionality of the server that issued the faulty software update.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices, such as one or more primary storage devices or secondary storage devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, ASICs, FPGAs, DSPs, or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the system, for example the one or more processors may be a remote processor (e.g., a cloud based processor). Alternatively or additionally, the one or more processors may be internal and/or local to the system. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computer, special purpose computer, or special purpose processing machine including a processing unit, a system memory device, and a system bus that couples various system components including the system memory device to the processing unit. The system memory may be or include the primary storage device and/or the secondary storage device. One or more of the system memory, primary storage device, and secondary storage device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method for updating configuration data by a computer, the method implemented by the computer and comprising:
receiving updated configuration data from a control core;
storing earlier configuration data with a time stamp in an archive storing additional earlier configuration data with respective time stamps;
responsive to the updated configuration data not being faulty, distributing content using the updated configuration data; and
responsive to the updated configuration data being faulty:
communicating a fault to a monitoring system;
receiving and executing commands from the monitoring system to:
revert to an earlier configuration data stored in the archive and corresponding to a specific earlier time; and
disregard any further updated configuration data from the control core until instructed otherwise by the monitoring system; and
distribute content using the earlier configuration data to which the computer is reverted.

2. The method of claim 1, further comprising validating the updated configuration data, wherein the earlier configuration data is stored in the archive responsive to successfully validating the updated configuration data.

3. The method of claim 1, wherein the archive stores all earlier configuration data with respective time stamps within a predefined, rolling time window, and discards earlier configuration data with time stamps prior to that window.

4. The method of claim 3, wherein the window is 24 hours or less prior to a current time.

5. The method of claim 1, wherein the computer comprises a node in a content delivery network (CDN).

6. The method of claim 1, wherein the archive is stored in a mass storage device of the computer.

7. The method of claim 1, wherein the commands from the monitoring system use a secure shell (SSH) protocol.

8. A computer system comprising a processor, a storage device, and a network interface, the processor being configured to implement operations comprising:
receiving updated configuration data from a control core;
storing earlier configuration data with a time stamp in an archive storing additional earlier configuration data with respective time stamps;
responsive to the updated configuration data not being faulty, distributing content using the updated configuration data; and
responsive to the updated configuration data being faulty:
communicating a fault to a monitoring system;
receiving and executing commands from the monitoring system to:
revert to an earlier configuration data stored in the archive and corresponding to a specific earlier time; and
disregard any further updated configuration data from the control core until instructed otherwise by the monitoring system; and
distribute content using the earlier configuration data to which the computer is reverted.

9. The computer system of claim 8, the operations further comprising validating the updated configuration data, wherein the earlier configuration data is stored in the archive responsive to successfully validating the updated configuration data.

10. The computer system of claim 8, wherein the archive stores all earlier configuration data with respective time stamps within a predefined, rolling time window, and discards earlier configuration data with time stamps prior to that window.

11. The computer system of claim 10, wherein the window is 24 hours or less prior to a current time.

12. The computer system of claim 8, wherein the computer system comprises a node in a content delivery network (CDN).

13. The computer system of claim 8, wherein the archive is stored in the storage device.

14. The computer system of claim 8, wherein the commands from the monitoring system use a secure shell (SSH) protocol.

15. A method for updating configuration data, the method implemented by a computer and comprising:
receiving respective communications of fault from one or more nodes after the nodes receive updated configuration data from a control core; and
responsive to receiving the communications of fault, commanding the one or more nodes to:
revert to earlier configuration data corresponding to a specific earlier time; and
disregard any further updated configuration data from the control core until instructed otherwise.

16. The method of claim 15, wherein the specific earlier time is 24 hours or less prior to a current time.

17. The method of claim 15, wherein the computer comprises a monitoring system in a content delivery network (CDN).

18. A computer system comprising a processor and a network interface, the processor being configured to implement operations comprising:
receiving respective communications of fault from one or more nodes after the nodes receive updated configuration data from a control core; and
responsive to receiving the communications of fault, commanding the one or more nodes to:
revert to earlier configuration data corresponding to a specific earlier time; and
disregard any further updated configuration data from the control core until instructed otherwise.

19. The computer system of claim 18, wherein the specific earlier time is 24 hours or less prior to a current time.

20. The computer system of claim 15, wherein the computer system comprises a monitoring system in a content delivery network (CDN).

21. A method for updating configuration data by a computer, the method implemented by the computer and comprising:
receiving a software update from a server;
storing an earlier software version with a time stamp in an archive storing additional earlier software versions with respective time stamps;
responsive to the software update not being faulty, operating the software using the software update; and
responsive to the software update being faulty:
communicating a fault to a monitoring system;
receiving and executing commands from the monitoring system to:
revert to an earlier software version stored in the archive and corresponding to a specific earlier time; and
disregard any further software updates from the server until instructed otherwise by the monitoring system; and
operating the software using the software version to which the computer is reverted.

22. A method for updating configuration data, the method implemented by a computer and comprising:
receiving respective communications of fault from one or more computers after the computers receive a software update from a server; and
responsive to receiving the communications of fault, commanding the one or more computers to:
revert to an earlier software version corresponding to a specific earlier time; and
disregard any further software updates from the server until instructed otherwise.
